(19) United States
(12) Patent Application Publication
(10) Pub. No.: US 2010/0154652 A1
(43) Pub. Date: Jun. 24, 2010

(54) Electric Pot Keeping Food Warm and Infusing Aroma

(76) Inventor: Huang-Mei Wang, Taipei (TW)

Correspondence Address: SCHMEISER OLSEN & WATTS, 18 E UNIVERSITY DRIVE, SUITE # 101, MESA, AZ, 85201, US

(21) Appl. No.: 12/344,131

(22) Filed: Dec. 24, 2008

(51) Int. Cl. A47J 36/24; A47J 27/00

(52) U.S. Cl. 99/339; 99/325; 99/467

(57) ABSTRACT

An electric pot keeping food warm and infusing aroma comprises a main body, a water storage device, a manifold and a control module. The main body has an outer pot, an inner pot, a pot lid and a water inlet. The water storage device has a first water outlet and a second water outlet respectively arranged at different water levels. The manifold further has a first branch pipe to the first water outlet, a second branch pipe to the second water outlet, a first valve for the first branch pipe and a second valve for the second branch pipe. When the first/second valve opens, the first/second branch pipe allows water to flow from the water storage device into the outer pot via the first/second water outlet, the first/second valve, and the water inlet. Further, scented oil may be added into the water storage device to change or increase flavor of cooked rice.

### BACKGROUND OF INVENTION

1. Field of the Invention

The present invention relates to an electric pot, particularly to an electric pot that can automatically heat food, keep food warm, and infuse aroma via a control module.

2. Description of the Related Art

The electric pot is a necessary device for daily rice cooking or food heating. The conventional electric pots on the market can cook rice and keep warm rice. However, the longer rice is kept warm in an electric pot, the more water is evaporated from rice. Thus, rice will become harder and harder when the time of keeping warming increases. Therefore an electric pot is desired, which not only can cook and keep food warm but also can avoid the abovementioned problem, whereby people can still have succulent rice even after the electric pot has kept warm rice for hours.

### SUMMARY OF THE INVENTION

One objective of the present invention is to provide an electric pot for keeping food warm and infusing aroma, which comprises a main body, a water storage device, a manifold, and a control module. The main body further comprises an outer pot, an inner pot, a pot lid and a water inlet. The water storage device has a first water outlet and a second water outlet respectively arranged at different water levels and providing water necessary for cooking. The manifold is connected to the main body through the water inlet and further comprises a first branch pipe, a second branch pipe, a first valve and a second valve. The first branch pipe is connected to the first water outlet of the water storage device. The second branch pipe is connected to the second water outlet of the water storage device. The first valve is used to open or close the first branch pipe; when the first valve opens, the first branch pipe allows water to flow from the water storage device into the outer pot via the first water outlet, the first valve, and the water inlet. The second valve is used to open or close the second branch pipe; when the second valve opens, the second branch pipe allows water to flow from the water storage device into the outer pot via the second water outlet, the second valve, and the water inlet. The control module controls opening and closing of the first valve and the second valve.

Some of the features and advantages of the present invention are to be described below. Some other features and advantages of the present invention should be obvious for the persons skilled in the art from the following description, and some other features and advantages will be self-evident in the application of the present invention, although they are not directly stated thereinafter. In addition, realizing the claims stated below will embody the features and advantages of the present invention.

It should be noted that the foregoing schematic description and the following detailed description of the present invention is only to exemplify the present invention but not to limit the scope of the present invention.

### BRIEF DESCRIPTION OF THE DRAWINGS

FIG. 1 is a diagram schematically showing the appearance of an electric pot keeping food warm and infusing aroma according to one embodiment of the present invention;

FIG. 2 is a sectional view of the manifold of an electric pot keeping food warm and infusing aroma according to another embodiment of the present invention;

FIG. 3 is a diagram schematically showing the heating operation of an electric pot keeping food warm and infusing aroma according to yet another embodiment of the present invention;

FIG. 4 is a diagram schematically showing the keep-warm operation of an electric pot keeping food warm and infusing aroma according to still another embodiment of the present invention; and

FIG. 5 is a diagram schematically showing the operation of the check valve of an electric pot keeping food warm and infusing aroma according to a further embodiment of the present invention.

### DETAILED DESCRIPTION OF THE INVENTION

Below, the embodiments of the present invention are described in cooperation with the attached drawings. An identical numeral used in the description should direct to the identical or similar elements in the drawings.

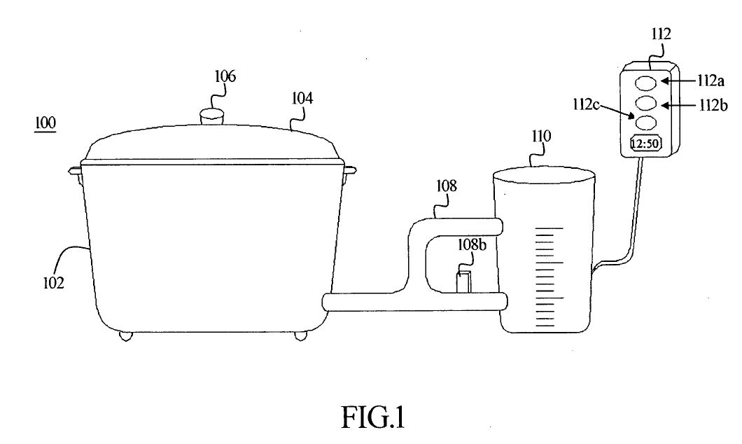

Referring to FIG. 1 a diagram schematically showing the appearance of an electric pot 100 keeping food warm and infusing aroma according to one embodiment of the present invention. The electric pot 100 keeping food warm and infusing aroma of the present invention comprises an outer pot 102, an inner pot (not shown in FIG. 1), a lid 104, a lid handle 106, a manifold 108, a water storage device 110, and a control module 112. The manifold 108 further comprises a first branch pipe (unmarked), a second branch pipe (unmarked), an electromagnetic valve 108b, and a check valve (not shown in FIG. 1). The control module 112 further comprises a heating button 112a, a keep-warm button 112b, and a time-setting button 112c. The main body of the electric pot 100 has a water inlet (unmarked). The water storage device 110 is used to store water for cooking and has a first water outlet (unmarked) and a second water outlet (unmarked) respectively arranged at different water levels. In one embodiment, the user may add scented oil into the water storage device 110 while cooking rice to change the flavor of the cooked rice or add a flavor to the cooked rice. In one embodiment, the scented oil may be a juice or a material that can cause an aroma or pleasant smell. For example, the user may add lavender oil into the water storage device 110 to cook a lavender-flavored rice.

The manifold 108 is coupled to the water inlet of the main body. The first branch pipe is connected to the first water outlet of the water storage device 110. The second branch pipe is connected to the second water outlet of the water storage device 110. The check valve is used to open or close the first branch pipe. When the check valve opens, the first branch pipe allows water to flow from the water storage device 110 into the main body via the first water outlet, the check valve, and the water inlet. The electromagnetic valve 108b is used to open or close the second branch pipe. When the electromagnetic valve 108b opens, the second branch pipe allows water to flow from the water storage device 110 into the main body via the second water outlet, the electromagnetic valve 108b, and the water inlet. The control module 112 controls opening and closing of the check valve and the electromagnetic valve 108b.

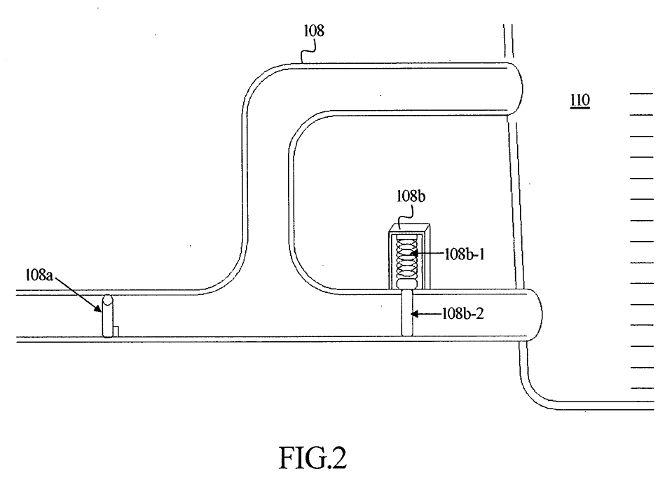

Referring to FIG. 2 a sectional view of the manifold 108 of an electric pot 100 keeping food warm and infusing aroma according to another embodiment of the present invention. The manifold 108 has a check valve 108a. The check valve 108a allows water to flow to a first side (the right side where the check valve 108b exists) to a second side (the left side) but prevents steam from flowing from the second side to the first side. In the electromagnetic valve 108b, the control module 112 controls an electromagnetic-actuated spring 108b-1 to open the gate 108b-2.

The control module 112 further comprises a timer device. Once the check valve 108a opens, the timer device begins to countdown to a designated time. When the designated time is reached, the control module 112 opens the electromagnetic valve 108b. In another embodiment, when the designated time is reached, the control module 112 closes the check valve 108a. Besides, the timer device is also used to preset a designated time.

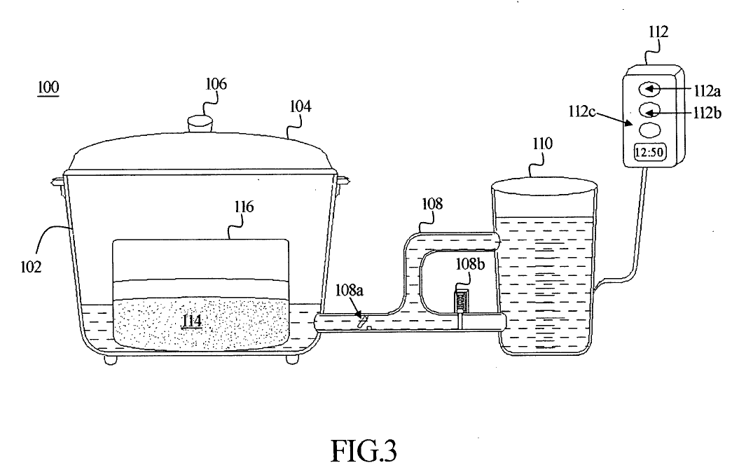

Referring to FIG. 3 a diagram schematically showing the heating operation of an electric pot 100 keeping food warm and infusing aroma according to yet another embodiment of the present invention. When the heating button 112a is pressed down, water flows from the first branch pipe of the manifold 108 through the check valve 108a into the main body for cooking rice 114 contained inside an inner pot 116.

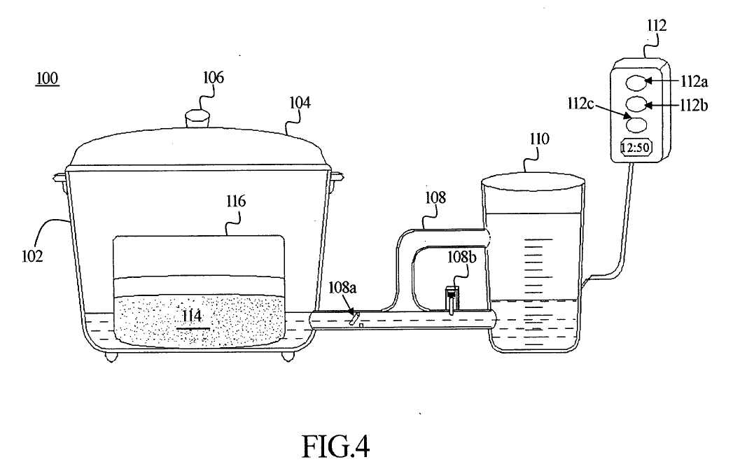

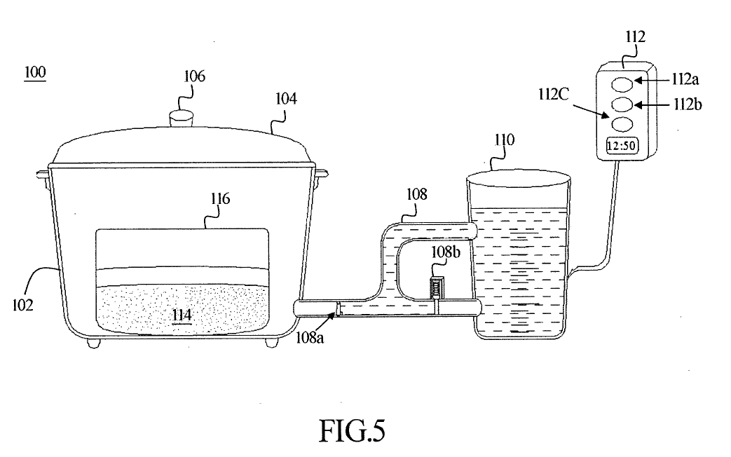

Referring to FIG. 4 a diagram schematically showing the keep-warm operation of an electric pot 100 keeping food warm and infusing aroma according to still another embodiment of the present invention. When the keep-warm button 112b is pressed down, water flows from the second branch pipe of the manifold 108 through the electromagnetic valve 108b into the main body for generating steam, which prevents rice 114 from being hardened by water evaporation during the keep-warm process. In another embodiment, the timer device can be preset to switch the heating process into the keep-warm process after rice has been cooked well for a given interval of time. Referring to FIG. 5 a diagram schematically showing the operation of the check valve 108a of an electric pot 100 keeping food warm and infusing aroma according to a further embodiment of the present invention. The check valve 108a only allows water to flow from the right side to the left side but prevents water or steam from flowing reversely back to the water storage device 110.

It should be understood that the embodiments described above are only to exemplify the present invention but not to limit the scope of the present invention, and that any equivalent modification or variation according to the spirit of the present invention is to be also included within the scope of the present invention.

What is claimed is:

1. An electric pot keeping food warm and infusing aroma, comprising
a main body further comprising an outer pot, an inner pot, a pot lid and a water inlet;
a water storage device having a first water outlet and a second water outlet respectively arranged at different water levels and providing water necessary for cooking;
a manifold connected to said main body through said water inlet and further comprising
a first branch pipe connected to said first water outlet of said water storage device;
a second branch pipe connected to said second water outlet of said water storage device;
a first valve used to open or close said first branch pipe, wherein when said first valve opens, said first branch pipe allows water to flow from said water storage device into said outer pot via said first water outlet, said first valve, and said water inlet;
a second valve used to open or close said second branch pipe, wherein when said second valve opens, said second branch pipe allows water to flow from said water storage device into said outer pot via said second water outlet, said second valve, and said water inlet; and
a control module used to control opening and closing of said first valve and said second valve.

2. The electric pot keeping food warm and infusing aroma according to claim 1, wherein said first valve is a check valve allowing water to flow from said water storage device to said outer pot and stopping water flowing from said outer pot to said water storage device.

3. The electric pot keeping food warm and infusing aroma according to claim 1, wherein said second valve is an electromagnetic valve.

4. The electric pot keeping food warm and infusing aroma according to claim 1, wherein said control module further comprising a timer device.

5. The electric pot keeping food warm and infusing aroma according to claim 4, wherein once said first valve opens, said timer device begins to countdown to a designated time; when said designated time is reached, said control module opens said second valve.

6. The electric pot keeping food warm and infusing aroma according to claim 5, wherein when said designated time is reached, said control module closes said first valve.

7. The electric pot keeping food warm and infusing aroma according to claim 5, wherein said designated time is preset with said timer device.

8. The electric pot keeping food warm and infusing aroma according to claim 1, wherein scented oil is added into said water storage device to change or increase flavor of cooked rice.
